(19) United States
(12) Patent Application Publication
(10) Pub. No.: US 2014/0161927 A1
(43) Pub. Date: Jun. 12, 2014

(54) READY TO EAT SEAFOOD PATTIES, SEAFOOD BALLS, AND SEAFOOD BURGERS

(71) Applicant: Alice Chang, South Pasadena, CA (US)

(72) Inventor: Alice Chang, South Pasadena, CA (US)

(21) Appl. No.: 13/864,155

(22) Filed: Apr. 16, 2013

Related U.S. Application Data
(60) Provisional application No. 61/705,630, filed on Sep. 26, 2012.

(51) Int. Cl. A23L 1/325

(52) U.S. Cl. CPC A23L 1/3255
USPC 426/2; 426/643; 426/92

(57) ABSTRACT

A ready to eat seafood patties, seafood balls, and seafood burgers system having ingredients combined in proportions substantially including: seafood; binding agent; and seasoning. The seafood is cooked to make the seafood patty. The binding agent binds the seafood into desired different shapes and sizes of the seafood patties, balls, and burgers. The seafood, the binding agent, and the seasoning are combined. The seafood patties, balls, and burgers are high in nutrition, including protein, vitamins, and minerals, and less cholesterol than red meat and suitable for readily consuming

### CROSS-REFERENCE TO RELATED APPLICATION

The present application is related to and claims priority from prior provisional application Ser. No. 61/705,630, filed Sep. 26, 2012 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

1. Field of the Invention

The present invention relates generally to the field of comestibles and more specifically relates to ready to eat seafood patties, seafood balls, and seafood burgers.

2. Description of the Related Art

The majority of people desire a healthy lifestyle. Many individuals do not have time to cook healthy meals in modem society. Due to rushed schedules many individuals eat unhealthy foods that may lead to obesity and other serious health problems. Many foods such as seafood are healthier than red meats for example; however seafood may not typically come in a form that is readily conducive to easy preparation.

Seafood is generally any form of sea life regarded as food by humans. Seafood prominently includes fish and shellfish in most societies. Shellfish include various species of molluscs, crustaceans, and echinoderms. Seafood is consumed all over the world; it provides the worlds prime source of high-quality protein: 14-16% of the animal protein consumed world-wide; over one billion people rely on seafood as their primary source of animal protein. Fish is among the most common food eaten. Research over the past few decades has shown that the nutrients and minerals in seafood can make improvements in brain development and reproduction and has highlighted the role for seafood in the functionality of the human body. A more efficient and convenient option is needed to provide seafood for user consumption on a regular basis.

Various attempts have been made to solve the above-mentioned problems such as those found in U.S. Pat. Nos. 2004/0101603; U.S. Pat. No. 3,532,512; 2008/0254167; U.S. Pat. Nos. 3,607,315; 4,871,560; 2,798,814; and 2008/0014319. This art is representative of seafood comestibles. None of the above inventions and patents, taken either singly or in combination, is seen to describe the invention as claimed.

Ideally, a ready to eat seafood patties, seafood balls, and seafood burgers system should provide a nutritional seafood comestible that is convenient to prepare and desirable to eat and, yet would be able to be processed and manufactured at a modest expense. Thus, a need exists for a reliable ready to eat seafood patties, seafood balls, and seafood burgers system to avoid the above-mentioned problems.

### BRIEF SUMMARY OF THE INVENTION

In view of the foregoing disadvantages inherent in the known seafood comestibles art, the present invention provides novel ready to eat seafood patties, seafood balls, and seafood burgers. The general purpose of the present invention, which will be described subsequently in greater detail is to provide a nutritional seafood comestible that is convenient to prepare and desirable to eat.

The purpose of the present invention is to create patties, balls and burgers with seafood. The invention is to provide people that shop for food with the convenience of getting processed seafood patties, and people who eat at fast food restaurants with the choice of seafood burgers as a healthy alternative. Seafood patties can contain ground or minced seafood such as shrimp, crab, clam, oyster, scallop, lobster, abalone, conch, octopus, squid, jellyfish, cuttlefish, fish roe, shrimp roe, fish, and the like. Other seafood may include but is not limited to prawn, krill, mussel, sea cucumber, sea urchin, eel (including sea eel and freshwater eel), and snail (including land snail, sea snail and freshwater snail). Seafood patties can contain a single seafood such as shrimp, to make the shrimp patty and shrimp burger; or a combination of seafood(s) may alternately be used.

A ready to eat seafood patties, seafood balls, and seafood burgers system is disclosed herein comprising ingredients combined in proportions substantially including: at least one seafood; at least one binding agent; and at least one seasoning. The at least one seafood is cooked to make the seafood patty. The seafood comprises approximately ½-pound to 1 pound to create the seafood patty. The at least one binding agent binds the seafood into desired different shapes and sizes of the seafood patties, balls, and burgers. Approximately 1/10 to ½-of a pound of the binding agent is used for every 1 pound of seafood used (as per manufacturer or user preference). It should be noted that the amount of the binding agent needed depend on the type of seafood used to make the seafood patties, seafood balls, and seafood burgers. The seafood, the binding agent, and the seasoning are combined. Further, the ready to eat seafood patties, balls, and burgers are prepared by intermixing the seafood, the binding agent, and the seasonings, and when prepared they are cooked. The resulting seafood patties, balls, and burgers are high in nutrition, including protein, vitamins, and minerals, and less cholesterol than red meat suitable for readily consuming

A method of preparing ready to eat seafood patties, seafood balls, and seafood burgers system is also disclosed herein comprising the steps of: washing the seafood; removing any bones, shells, and internal organs from the seafood when necessary; grinding the seafood into an even and smooth texture; adding a binding agent thereby creating the seafood patties; cooking the seafood patty; seasoning the seafood patty; garnishing the seafood patty with a bun and condiments; consuming the seafood patty; and serving the ready to eat seafood patties, balls, and burgers system as hot food in restaurants, the ready to eat seafood patties, balls, and burgers system being packaged in (into) air tight containers to preserve freshness until ready for consumption.

The present invention holds significant improvements and serves as a ready to eat seafood patties, seafood balls, and seafood burgers systems. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, ready to eat seafood patties, seafood balls, and seafood burgers system, constructed and operative according to the teachings of the present invention.

FIG. 1A shows a perspective view illustrating a ready to eat seafood patties, seafood balls, and seafood burgers system in an in-use condition according to an embodiment of the present invention.

FIG. 1B shows a perspective view illustrating a ready to eat seafood patties, seafood balls, and seafood burgers system in an in-use condition according to an embodiment of the present invention.

FIG. 2 is a perspective view illustrating the ready to eat seafood patties, seafood balls, and seafood burgers system contents as used to make embodiments of the present invention of FIG. 1A.

FIG. 3 is a flowchart illustrating a method of preparing the ready to eat seafood patties, balls, and burgers according to an embodiment of the present invention of FIGS. 1A-2.

The various embodiments of the present invention will hereinafter be described in conjunction with the appended drawings, wherein like designations denote like elements.

### DETAILED DESCRIPTION

As discussed above, embodiments of the present invention relate to comestibles and more particularly to a ready to eat seafood patties, seafood balls, and seafood burgers system as used to improve the convenience of preparing and eating of (including) seafood in an individual's diet and thus the overall health of the consumer.

Generally speaking, the purpose, as previously mentioned, is to create healthy comestibles; patties, balls and burgers comprising seafood. The seafood patties can contain ground or minced seafood such as shrimp, crab, clam, oyster, scallop, lobster, abalone, conch, octopus, squid, jellyfish, cuttlefish, fish roe, shrimp roe, fish, or the like. Other seafood may include but is not limited to prawn, krill, mussel, sea cucumber, sea urchin, eel (including sea eel and freshwater eel), and snail(including land snail, sea snail and freshwater snail). Seafood patties can contain a single seafood such as shrimp, to make shrimp patties and shrimp burger; or a combination of seafood may be used. The seafood (combination) may be tailor-designed to meet specific dietary needs of certain diets.

A binding agent in cooking such as oil, spices, flour, baking soda, vegetable starch, corn starch, potato starch, gelatin, egg white, and beaten egg can be used to bind the seafood into different shapes and sizes of the patties. Seafood patties are shaped into round or square patties. Round patties can have a diameter of about 3 to 4 inches. Square patties can have each side of about 3 to 4 inches. And the patties can have a thickness of about ½ to 1 inch. Other shapes and sizes can also be considered, such as spherical shape, with a diameter of about 1 to 2 inches, to make seafood balls.

After the seafood is ground or minced, and before or during the process of applying the binding agent, other ingredients that are ground, minced, semi-solid, or liquid, can be added and mixed with the seafood and the binding agent. The other ingredients include egg, meat, vegetable, herb, fruit, cereal, nut, bean, cheese, butter, and so on. On the other hand, after the binding agent is applied to the ground or minced seafood, it can wrap around the other ingredients that are ground, minced, semi-solid, or liquid, so that the other ingredients are in the core. The ground or minced seafood with binding agent and other ingredients can also be used to wrap around the other ingredients, which are to form the core of the seafood patties and seafood balls.

The seafood patties (as manufactured) can be purchased cooked and ready to eat with bread buns, potatoes, rice, pasta, etc. The patties, balls and burgers with seafood can be cooked by deep frying, grilling, boiling, baking, steaming, or the like and they can be seasoned with salt, pepper, onion, garlic, ginger, curry, chili, vinegar, lemon, lime, peppermint, basil, thyme, parsley, rosemary, soup stock and broth, clove, cinnamon, coriander, cumin, shallots, or other seasonings. At fast food restaurants, the seafood patties can be deep fried and placed inside a sliced bread roll to make a seafood burger. The seafood burger can be served with lettuce, onions, tomatoes, pickles, cheese, and condiments such as mustard, mayonnaise, ketchup, and relish. The seafood balls can be served as an appetizer. The seafood patties and balls can have no outer layer in preferred embodiments. An outer layer of bread crumbs or batter, such as beer batter, egg batter, or cornmeal batter, can also be added in alternate embodiments.

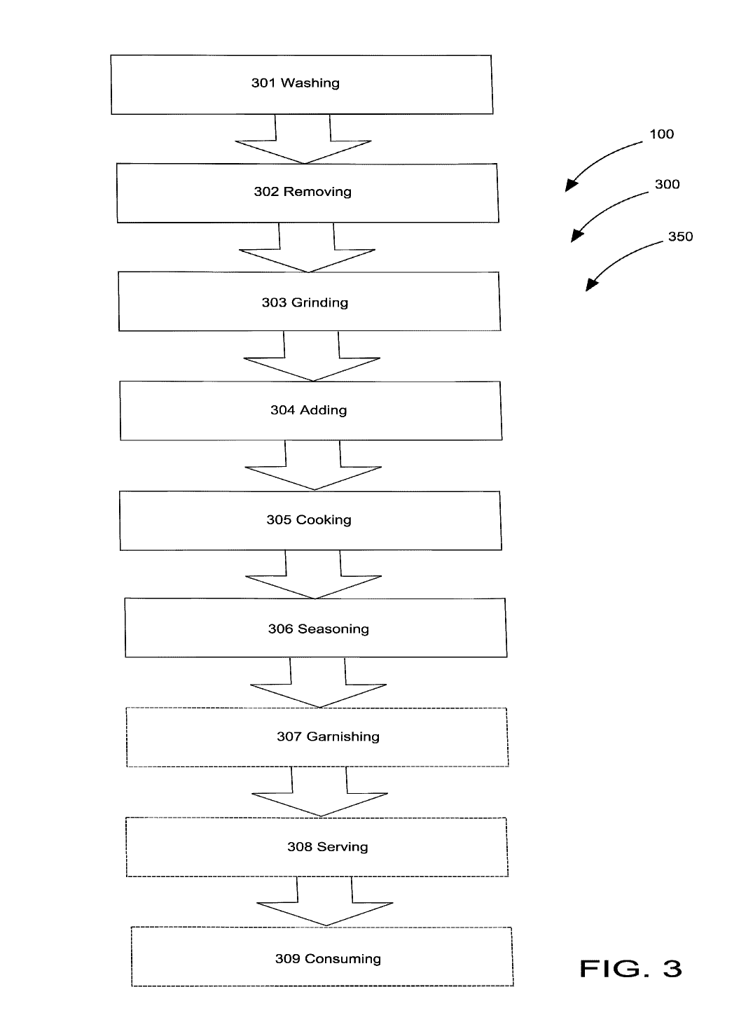

Making of the seafood patties as discussed in further detail in FIG. 3 includes washing; removal of bones, shells, and internal organs; grinding; adding binding agent; cooking and seasoning. Processed seafood patties save people time and energy to obtain seafood as a meal. Seafood provides a good source of nutrition, including protein, vitamins and minerals, and comprises less cholesterol than red meat.

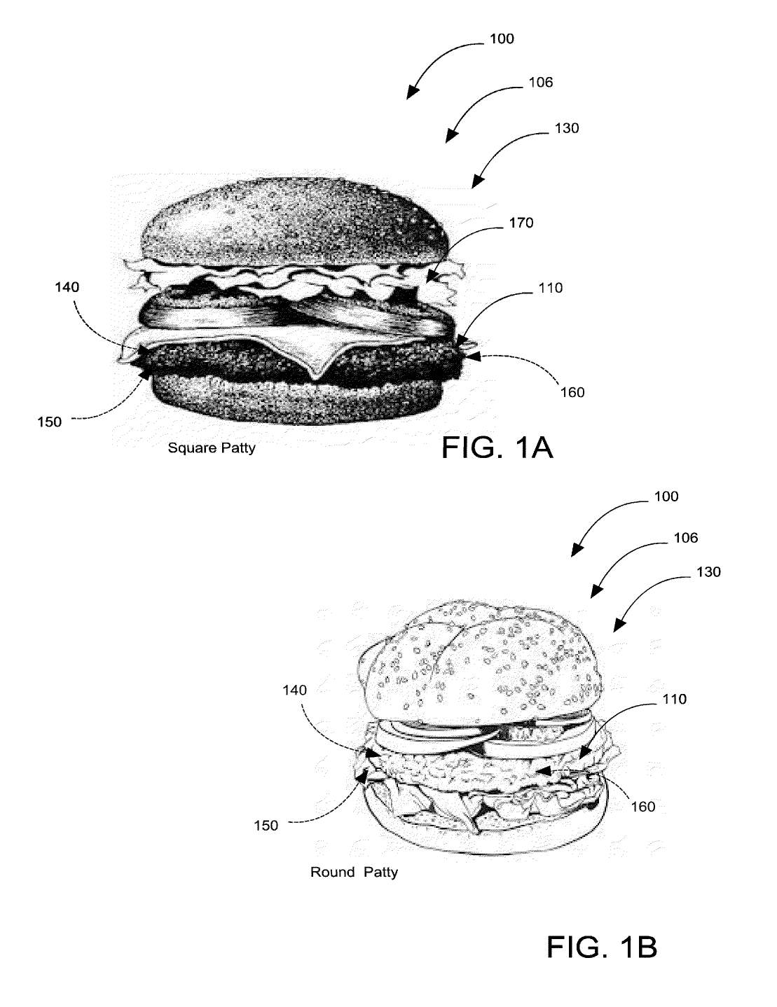

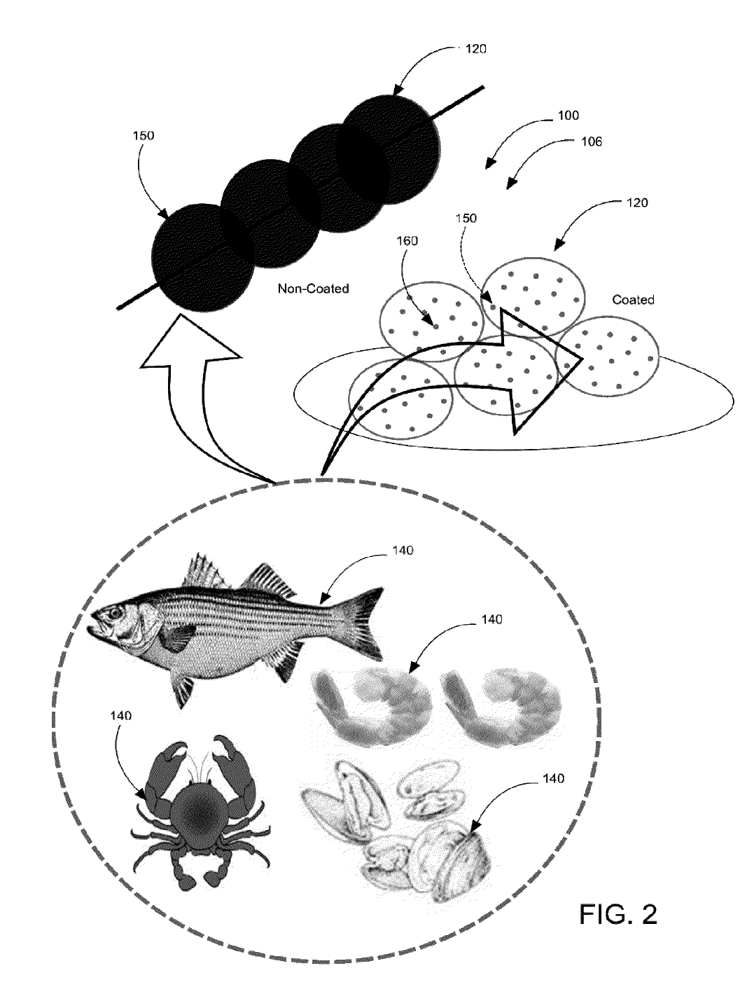

Referring to the drawings by numerals of reference there is shown in FIGS. 1A-2 showing perspective views illustrating ready to eat seafood patties 110, seafood balls 120, and seafood burgers 130 (once prepared to be eaten), to be prepared both according to embodiments of the present invention.

Ready to eat seafood patties 110, seafood balls 120, and seafood burgers 130 system 100 comprises ingredients combined in proportions substantially including: at least one seafood 140; at least one binding agent 150; and at least one seasoning 160. Seafood 140 is preferably cooked to make patties 110, seafood balls 120, and seafood burgers 130. Seafood 140, binding agent 150, and seasoning 160 are combined. Seafood patties 110, balls 120, and burgers 130 are prepared by intermixing seafood 140, binding agent 150, and seasonings 160, when prepared are cooked, seafood patties 110, seafood balls 120, and seafood burgers 130 are high in nutrition, including protein, vitamins, and minerals, and less cholesterol than red meat suitable for readily consuming It should be noted that other ingredients such as cheese, pickle, tomato, onion, and the like may be added as per consumer preference to dress ready to eat seafood patties 110, seafood balls 120, and seafood burgers 130 system 100.

Seafood 140 is preferably ground up or minced. Further, seafood 140 preferably comprises approximately ½ pound to 1 pound to create seafood patty 110 or seafood burger 130 (approximately 250 g to 500 g) while approximately ⅛ to ¼ pound of seafood 140 is required to make seafood balls 120 (approximately 62.5 g to 125 g). Seafood 140 may comprise an outer coating in preferred embodiments. The outer coating (when used) is selected from the group consisting of bread crumbs, beer batter, egg batter, and cornmeal batter. In preferred embodiments, seafood 140 may comprises no outer coating since it is healthier for consumption.

At least one binding agent 150 preferably binds seafood 140 into desired different shapes and sizes of seafood patties 110, seafood balls 120, and seafood burgers 130. Approximately 1/10 to ½-of a pound of binding agent 150 is used for every 1 pound of seafood 140 used. It should be noted that the amount of binding agent 150 needed depend on the type of seafood used to make seafood patties 110, seafood balls 120, and seafood burgers 130. Binding agent 150 preferably comprises oil, spices, flour, baking soda, vegetable starch, corn starch, potato starch, gelatin, egg white, and beaten egg, but other suitable binding agents 150 may be used. More binding agent 150 may be used on embodiments without outer coating.

Seafood patties 110 may comprise cubical shapes or disks. Seafood patties 110 are approximately 3 to 4 inches in length, have a thickness of approximately ½ to 1-inch in thickness, and are as such that they may be evenly and thoroughly cooked. Seafood patties 110 may be served in combination with and selected from the group consisting of bread buns, potatoes, rice, and pasta. Additionally, seafood balls 120 may be spherical (shown) or cubical (not shown) in shape and comprise a diameter of approximately 1-2 inches.

Cooking means for cooking seafood 140 when cooked are selected from the group consisting of deep frying, grilling, boiling, baking, and steaming. Seafood(s) 140 are selected from the group consisting of shrimp, crab, clam, oyster, scallop, lobster, abalone, conch, octopus, squid, jellyfish, cuttlefish, fish roe, shrimp roe, and fish. Other seafood 140 may include but is not limited to prawn, krill, mussel, sea cucumber, sea urchin, eel (including sea eel and freshwater eel), and snail(including land snail, sea snail and freshwater snail). Ready to eat seafood patties 110, seafood balls 120, and seafood burgers 130 system 100 may include at least 2 combinations of seafood(s) 140. Many other seafood and combinations thereof may be envisioned to be used and still be considered within the scope of the present invention.

Further, at least one seasoning 160 may be selected from the group consisting of salt, pepper, onion, garlic, ginger, curry, chili, vinegar, lemon, lime, peppermint, basil, thyme, parsley, rosemary, soup stock and broth, clove, cinnamon, coriander, cumin, shallots, or other seasonings. Ready to eat seafood patties 110, seafood balls 120, and seafood burgers 130 system 100 further comprises at least one condiment 170; condiment(s) 170 are selected from the group consisting of mustard, relish, ketchup, mayonnaise, tartar sauce, chili sauce, wasabi, and honey.

Ready to eat seafood patties 110, seafood balls 120, and seafood burgers 130 system 100 can be packaged into air tight containers to preserve freshness until ready to serve. The containers can be made of paper, plastic, glass, metal. In this way the present invention may be easily shipped and stored.

Referring now to FIG. 3, a flowchart 350 illustrating a method of preparing 300 ready to eat seafood patties 110, seafood balls 120, and seafood burgers 130 system 100 according to embodiments of the present invention of FIGS. 1A-2.

A method of preparing 300 ready to eat seafood patties 110, seafood balls 120, and seafood burgers 130 system 100 comprises the steps of: step one 301 washing seafood; step two 302 removing bones, shells, and internal organs from the seafood when necessary; step three 303 grinding the seafood into an even and smooth texture; step four 304 adding a binding agent thereby creating the seafood patties; step five 305 cooking the seafood patty; step six 306 seasoning the seafood patty; step seven 307 garnishing the seafood patty with a bun and condiments; step eight 308 consuming the seafood patty; and step nine 309 serving the ready to eat seafood patties, seafood balls, and seafood burgers system as hot food in restaurants, the ready to eat seafood patties, seafood balls, and seafood burgers system are packaged into air tight containers to preserve freshness until ready for consumption.

It should be noted that steps 307-09 are optional steps and may not be implemented in all cases. Optional steps of method 300 are illustrated using dotted lines in FIG. 3 so as to distinguish them from the other steps of method 300.

It should be noted that the steps described in the method of use can be carried out in many different orders according to user preference. The use of “step of should not be interpreted as “step for”, in the claims herein and is not intended to invoke the provisions of 35 U.S.C. §112, ¶6. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A ready to eat seafood patties, balls, and burgers system comprising ingredients combined in proportions substantially including:
at least one seafood;
at least one binding agent; and
at least one seasoning;
wherein said at least one seafood is cooked to make said seafood patty;
wherein said at least one binding agent binds said seafood into desired different shapes and sizes of said seafood patties, said balls, and said burgers;
wherein said seafood, said binding agent, and said seasoning are combined; and
wherein said ready to eat said seafood patties, said balls, and said burgers are prepared by intermixing said seafood, said binding agent, and said seasonings, when prepared are cooked, said seafood patties, said balls, and said burgers are high in nutrition, including protein, vitamins, and minerals, and less cholesterol than red meat suitable for readily consuming.

2. The ready to eat seafood patties, balls, and burgers system of claim 1 wherein said seafood is ground up.

3. The ready to eat seafood patties, balls, and burgers system of claim 1 wherein said seafood is minced.

4. The ready to eat seafood patties, balls, and burgers system of claim 1 wherein said seafood comprises no outer coating.

5. The ready to eat seafood patties, balls, and burgers system of claim 1 wherein said seafood comprises an outer coating.

6. The ready to eat seafood patties, balls, and burgers system of claim 5 wherein said outer coating is selected from the group consisting of bread crumbs, beer batter, egg batter, and cornmeal batter.

7. The ready to eat seafood patties, balls, and burgers system of claim 1 wherein said seafood patties comprise cubical shapes.

8. The ready to eat seafood patties, balls, and burgers system of claim 1 wherein said seafood patties comprise disks.

9. The ready to eat seafood patties, balls, and burgers system of claim 7 wherein said seafood patties are approximately 3 to 4 inches in length and have a thickness of approximately ½ to 1-inch in thickness such that they may be evenly and thoroughly cooked.

10. The ready to eat seafood patties, balls, and burgers system of claim 1 wherein said seafood patties are served in combination with and selected from the group consisting of bread buns, potatoes, rice, and pasta.

11. The ready to eat seafood patties, balls, and burgers system of claim 1 wherein said seafood balls are spherical in shape and comprise a diameter of approximately 1-2 inches.

12. The ready to eat seafood patties, balls, and burgers system of claim 1 wherein said binding agent is selected from the group consisting of oil, spices, flour, baking soda, vegetable starch, corn starch, potato starch, gelatin, egg white, and beaten egg.

13. The ready to eat seafood patties, balls, and burgers system of claim 1 wherein said cooking means when cooked are selected from the group consisting of deep frying, grilling, boiling, baking, and steaming.

14. The ready to eat seafood patties, balls, and burgers system of claim 1 wherein said seafood(s) are selected from the group consisting of shrimp, crab, clam, oyster, scallop, lobster, abalone, conch, octopus, squid, jellyfish, cuttlefish, fish roe, shrimp roe, fish, prawn, hill, mussel, sea cucumber, sea urchin, eel, and snail.

15. The ready to eat seafood patties, balls, and burgers system of claim 14 wherein said seafood(s) includes at least 2 combinations of said seafood(s).

16. The ready to eat seafood patties, balls, and burgers system of claim 1 wherein said at least one seasoning is selected from the group consisting of salt, pepper, onion, garlic, ginger, curry, chili, vinegar, lemon, lime, peppermint, basil, thyme, parsley, rosemary, soup stock and broth, clove, cinnamon, coriander, cumin, and shallots.

17. The ready to eat seafood patties, balls, and burgers system of claim 1 wherein said cooked ready to eat seafood patties, balls, and burgers system are packaged into air tight containers to preserve freshness.

18. A ready to eat seafood patties, balls, and burgers system comprising ingredients combined in proportions substantially including:
at least one seafood;
at least one binding agent; and
at least one seasoning; and
at least one condiment;
wherein said at least one seafood is cooked to make said seafood patty;
wherein said at least one binding agent binds said seafood into desired different shapes and sizes of said seafood patties, said balls, and said burgers;
wherein said seafood, said binding agent, and said seasoning are combined;
wherein said seafood is ground up;
wherein said seafood comprises an outer coating;
wherein said outer coating is selected from the group consisting of bread crumbs, beer batter, egg batter, and cornmeal batter;
wherein said seafood patties comprise cubical shapes;
wherein said seafood patties are approximately 3 to 4 inches in length and have a thickness of approximately ½ to 1-inch in thickness such that they may be evenly and thoroughly cooked;
wherein said seafood patties are served in combination with and selected from the group consisting of bread buns, potatoes, rice, and pasta;
wherein said seafood balls are spherical in shape and comprise a diameter of approximately 1-2 inches;
wherein said binding agent is selected from the group consisting of corn oil, spices, flour, baking soda, vegetable starch, corn starch, potato starch, gelatin, egg white, and beaten egg;
wherein said cooking means when cooked are selected from the group consisting of deep frying, grilling, boiling, baking, and steaming;
wherein said seafood(s) are selected from the group consisting of shrimp, crab, clam, oyster, scallop, lobster, abalone, conch, octopus, squid, jellyfish, cuttlefish, fish roe, shrimp roe, fish, prawn, hill, mussel, sea cucumber, sea urchin, eel, and snail;
wherein said seafood(s) includes at least 2 combination of said seafood(s);
wherein said at least one seasoning is selected from the group consisting of salt, pepper, onion, garlic, ginger, curry, chili, vinegar, lemon, lime, peppermint, basil, thyme, parsley, rosemary, soup stock and broth, clove, cinnamon, coriander, cumin, and shallots;
wherein said condiment(s) are selected from the group consisting of mustard, relish, ketchup, mayonnaise, tartar sauce, chili sauce, wasabi, and honey
wherein said ready to eat said seafood patties, said balls, and said burgers are prepared by intermixing said seafood, said binding agent, and said seasonings,
when prepared are cooked, said seafood patties, said balls, and said burgers are high in nutrition, including protein, vitamins, and minerals, and less cholesterol than red meat suitable for readily consuming.

19. A method of preparing ready to eat seafood patties, balls, and burgers system comprising the steps of:
washing seafood;
removing bones, shells, and internal organs from said seafood when necessary;
grinding the seafood into an even and smooth texture;
adding a binding agent thereby creating said seafood patties;
cooking said seafood patty;
seasoning said seafood patty;
garnishing said seafood patty with a bun and condiments; and
serving said ready to eat seafood patties, balls, and burgers system as hot food in restaurants, said ready to eat seafood patties, balls, and burgers comestibles are packaged into air tight containers to preserve freshness until ready for consumption.

20. The method of claim 19 further comprising the step of consuming said seafood patty.
